(19) United States
(12) Patent Application Publication
(10) Pub. No.: US 2024/0166373 A1
(43) Pub. Date: May 23, 2024

(54) Digital Removal and Installation Logging Process in Aircraft Maintenance

(71) Applicant: Zach Sanford, Soddy Daisey, TN (US)

(72) Inventor: Zach Sanford, Soddy Daisey, TN (US)

(21) Appl. No.: 18/057,679

(22) Filed: Nov. 21, 2022

(51) Int. Cl. B64F 5/40; B64F 5/60; G06Q 10/20

(52) U.S. Cl. CPC B64F 5/40; B64F 5/60; G06Q 10/20

(57) ABSTRACT

A software application to digitalize the logging process of removal and installation in aircraft maintenance. Whether it be a personal device or company supplied device this software application may help alleviate and mitigate the current problems with paper record keeping of aircraft component removal and installation.

### FIELD OF THE INVENTION

The present invention relates generally to an apparatus that may be used in aircraft maintenance. More particularly, the present invention is related to a software application to digitalize the logging process of removal and installation of components in aircraft maintenance.

### BACKGROUND

During aircraft maintenance at a repair station, there are many different processes set in place. One particular process is the removal and installation log. This is used to ensure that nothing is left behind and all parts are reinstalled after the maintenance event.

This current process is handwritten, manually stamped and labeled by the individual as the parts are being removed and installed (“R&I”). There are a few variations of an R&I log and they all have the same core problems.

These problems consist of illegible writing, improper book placement, lost pages, improper stamping, poor part label nomenclature, missed steps, and missing dates. Fixing these issues is very time consuming.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention are directed towards a software application to digitalize the logging process of removal and installation of components in aircraft maintenance. Whether it be a personal device or company supplied device this software application may help alleviate and mitigate the current problems with the paper record keeping.

### BRIEF DESCRIPTION OF THE DRAWINGS

The following drawings are intended to serve as exemplary embodiments of the features disclosed in the present disclosure.

FIG. 1 is a flowchart illustrating an exemplary process in accordance with embodiments of the present invention.

FIG. 2. is a diagram illustrating an exemplary digital logging system for aircraft maintenance.

FIG. 3 is a diagram illustrating a computer system 800 adapted according to certain embodiments of the server and/or the user interface device.

FIG. 4 is a block diagram illustrating a server hosting an emulated software environment for virtualization according to one embodiment of the disclosure.

### DETAILED DESCRIPTION OF DRAWINGS

The description of illustrative embodiments according to principles of several illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits are illustrated by reference to certain exemplified embodiments and may not apply to all embodiments.

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

Embodiments of the present invention are directed towards a software application to digitalize the logging process of removal and installation in aircraft maintenance. Whether it be a personal device or company supplied device this software application may help alleviate and mitigate the current problems with the paper record keeping.

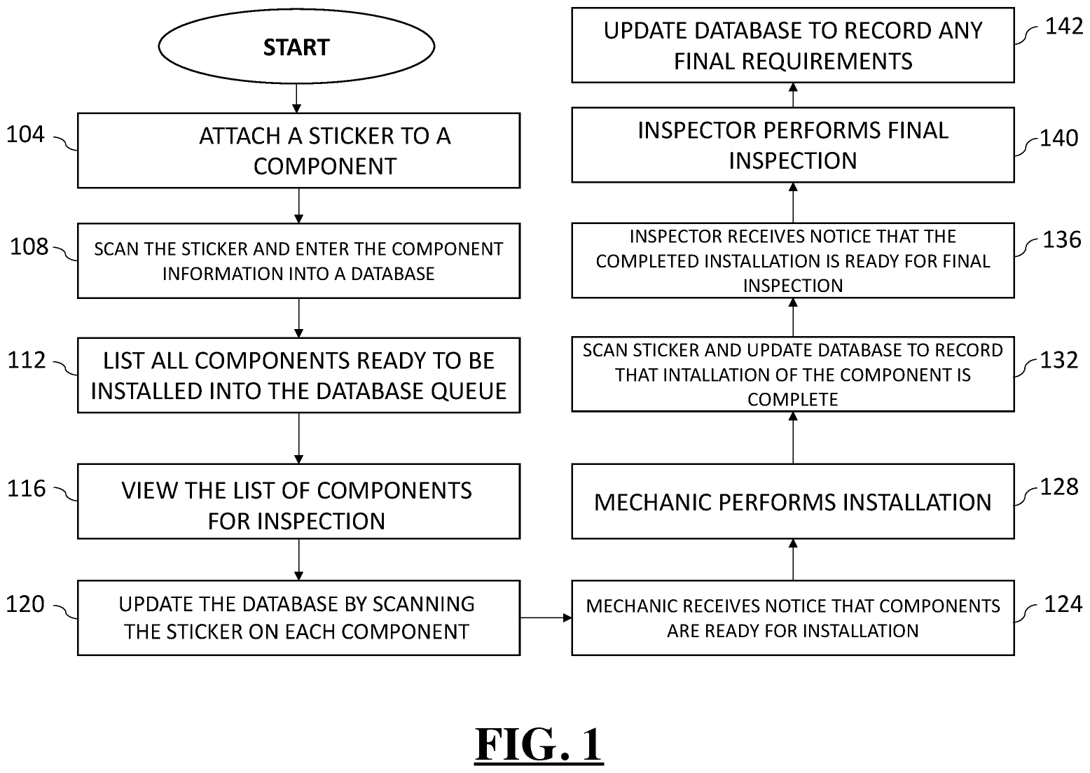

FIG. 1 is a flowchart illustrating an exemplary process in accordance with embodiments of the present invention.

First, information relating to a component of an aircraft is entered into a database. At step 104, an aircraft component is removed and receives a scannable sticker or identifier. The scannable sticker may comprise a QR code, a barcode, a nearfield communication (NFC) chip, radio-frequency identification (RFID) or the like. In some embodiments, the sticker is replaced with other suitable means for identifying a component, including affixing an identifying symbol or symbol(s) to a component by means of engraving, embossing, etching, painting, and the like. In some embodiments, the identifier is a laser engraved serial number. In some other embodiments, the identifier is an embossed metal serial number. While the term “sticker” is used throughout the present disclosure, it should be understood that similar terms such as “sticker”, “identifier”, “symbol”, “ID tag”, and the like may be used interchangeably without departing from the spirit and scope of the present invention.

Next, at step 108, the sticker is scanned and the information relating to the sticker and the part upon which the sticker is affixed is entered into a database. In some embodiments, the information related to each component may include, but is not be limited to work order, aircraft, location, part designation, reason the component was removed, who removed the component, time stamp associated with the removal, type of inspection required for reinstallation, a note of any discrepancies, and the like. In some embodiments, an image corresponding to the part/sticker may be attached and entered into the database. In some other embodiments, a video of the repair may be attached and entered into the database.

In some embodiments, information includes historical information related to the component. The historical information related to the component may include, but is not limited to, the following: history of the component, history of the aircraft, history of where the aircraft has traveled, history of who serviced/repaired the component, history of discrepancies found while repairing/servicing the component, and the like.

In some embodiments, other information related to each component may include a color-coded classification corresponding to the condition of said component. Accordingly, the color green indicates that a component is repairable, the color yellow indicates that the component is serviceable, and the color red indicates that the component is rejected.

In some embodiments, the information includes licenses, certificates, and the like. In some embodiments, a user enters a supplemental type certificate (“STC”). In other embodiments, the user enters an airframe and powerplant (“A&P”) license.

Next, at step 112, the lead mechanic or authorized user can list all the parts that are ready to be installed into the database queue.

Next, at step 116, an inspector can view the list of components for inspection. Once the components pass inspection, then at step 120 the inspector can automatically update the database by scanning the stickers on each component.

Next, at step 124, the mechanic receives notice that the components are ready for installation. Next, at step 128, the mechanic performs the installation. Once the mechanic is done, at step 132 the mechanic may scan the sticker and the database will update again to show installation complete.

Next, at step 136, the inspector receives notice that the installation is ready for final inspection. Next, at step 140, the inspector preforms the final inspection. Finally, at step 142, the database is updated for any final requirements before the mechanic closes out the work order and/or item. It is contemplated that step 142 may be accomplished by manual updates without scanning the sticker or the like.

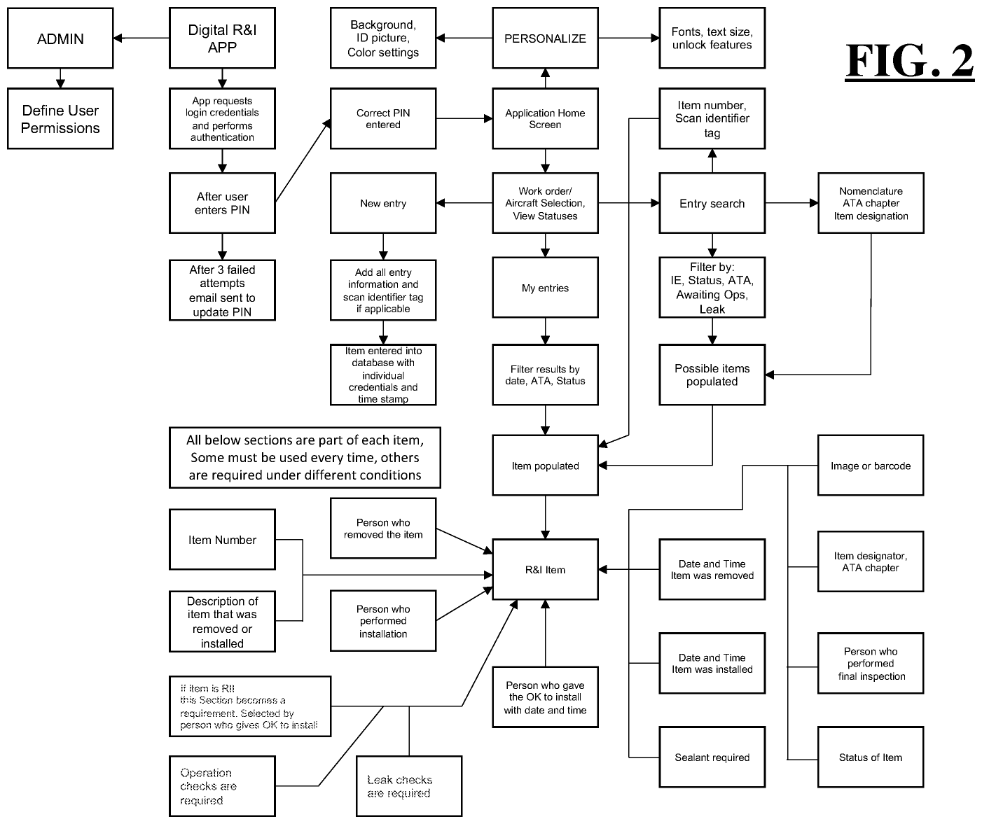

FIG. 2 is a block diagram illustrating an exemplary logging system for aircraft maintenance, in accordance with the present disclosure. The system may be adapted to perform the process disclosed herein the present disclosure. First, a user may access the digital removal and installation (“R&I”) application using a computer, or any suitable personal user interface device. The application requests login credentials and performs authentication. If the user enters the correct login credentials, PIN, password, or the like, then the user will be brought to the application home screen. If the user enters the wrong login credentials 3 times, then an email is sent to the user to update their login credentials. From the application home screen, the user may either personalize their user experience, or may continue to use the application R&I lookup features. The user may personalize their application background, ID picture, and color settings, as well as personalize the application's fonts, text sizes, and unlock additional features.

From the application home screen, the user may select a work order, select an aircraft, and/or view statuses. The user may select to see their entries under “My entries”. The user may subsequently filter the results by date, ATA chapter and/or item designation, or status. Then the R&I item may be populated and the R&I item is returned to the user.

The user may start a new search by entering nomenclature, ATA chapter, and/or item designation, which will result in possible items populated, and return a R&I item to the user. The user may filter searches according to IE, status, ATA, awaiting operation, leak, as well as by other classifications.

The R&I item will comprise of related information, including, but not limited to, the following: image of the component, ATA chapter, item designation, person who performed final inspection, status of item, date and time item was removed, date and time item was installed, the person who approved installation, and the time and place installation was approved, item number, description of item that was removed or installed, person who removed the item.

In some embodiments, the R&I item will further comprise of information including whether an operation check is required on the component. In some embodiments, the R&I item will further comprise of information including whether a leak check is required. In some embodiments, the R&I item will further comprise of information including whether sealant is required.

In some embodiments, different levels of authorization may be required to access different features of the application. Furthermore, different levels of authorization may be required to look up different components on the database. Accordingly, a user may have to possess the correct level of authorization to be able to look up a specific component on the database. With continued reference to FIG. 2, an administrator is shown able to define user permissions for the users of the application. Further, application administrators may view and manage user permissions in the application. Administrators can also add and configure applications, assign applications to end users, and create user accounts. In some embodiments, the administrator defines default permissions for new users. In some other embodiments, the administrator defines custom permission sets to each user to accomplish different levels of authorization allowing access to different features of the application.

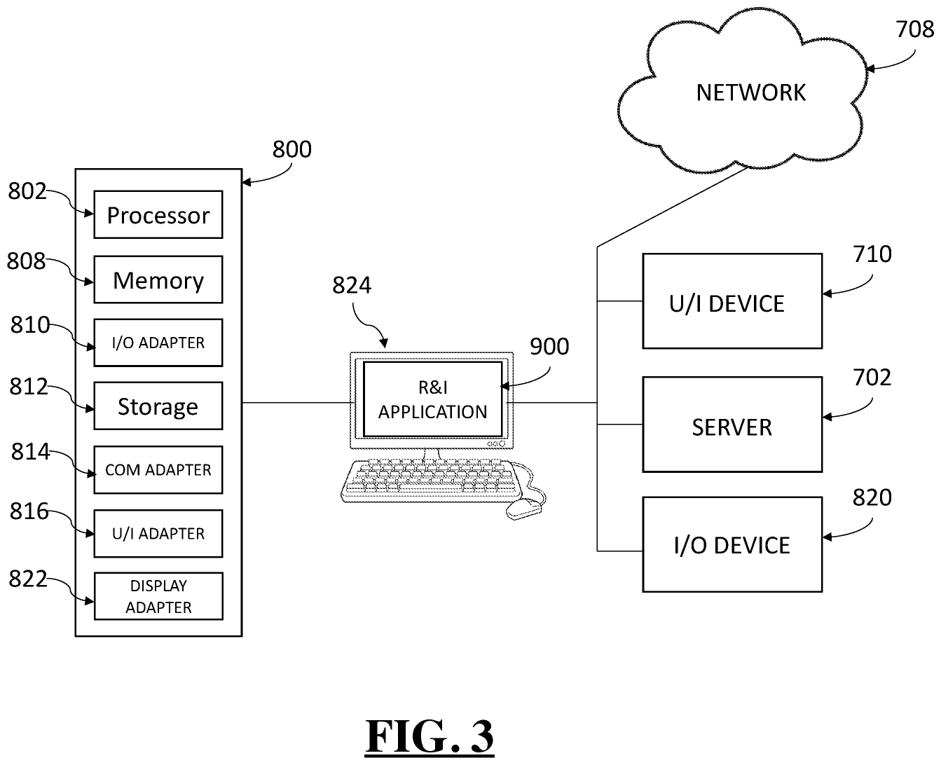

FIG. 3 illustrates a computer system 800 adapted according to certain embodiments of the server and/or the user interface device. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, as well as other adapters, including a display adapter. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 couples to one or more I/O devices 820. The I/O device may be any device suitable as to operate as a scanner configurable to scan an identifier on a component, such device being able to detect a QR code, a barcode, a nearfield communication (NFC) chip, radio-frequency identification (RFID), and the like. For example, the I/O device 820 may be a camera configurable to scan a QR code or a barcode to identify a component in a database. As another example, the device 820 may be an RFID sensor. As another example, the device 820 may be an NFC sensor.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network.

The I/O adapter 810 couples to user input devices, such as a keyboard, a pointing device, and/or a touch screen to the computer system 800. The keyboard may be an on-screen keyboard displayed on a touch panel. Additional devices (not shown) such as a camera, microphone, video camera, accelerometer, compass, and or gyroscope may be coupled to the user interface adapter. The display adapter may be driven by the CPU 802 to control the display on the display device. Any of the devices 810 may be physical and/or logical.

The applications of the present disclosure are not limited to the architecture of computer system 800. Rather the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

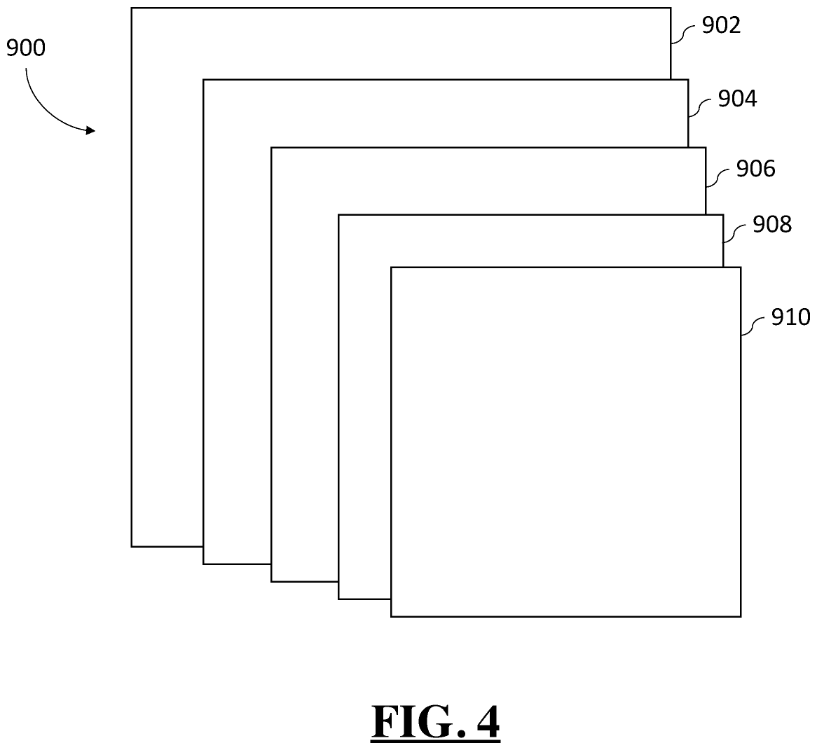

FIG. 4 is a block diagram illustrating a server hosting an emulated software environment for virtualization according to one embodiment of the disclosure. An operating system 902 executing on a server includes drivers for accessing hardware components, such as a networking layer 904 for accessing the communications adapter 814. The operating system 902 may be, for example, Linux. An emulated environment 908 in the operating system 902 executes a program 910, such as CPCommOS. The program 910 accesses the networking layer 904 of the operating system 902 through a non-emulated interface 906, such as XNIOP. The non-emulated interface 906 translates requests from the program 910 executing in the emulated environment 908 for the networking layer 904 of the operating system 902.

In another example, hardware in a computer system may be virtualized through a hypervisor. Users may access the hardware through a hypervisor. The hypervisor may be integrated with the hardware to provide virtualization of the hardware without an operating system, such as in the configuration illustrated in FIG. 4. The hypervisor may provide access to the hardware, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

Accordingly, the invention expressly should not be limited to such exemplary embodiments illustrating some possible non-limiting combination of features that may exist alone or in other combinations of features; the scope of the claimed invention being defined by the claims appended hereto.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method of digitally logging aircraft components comprising:
initiating a work order by entering information relating to an at least one component to be removed from an aircraft into a database comprising a queue,
applying an identifier to the at least one component to be removed from the aircraft,
scanning the identifier such that information relating to the identifier is recorded into the database,
entering a list of components that are ready to be installed into the database queue;
viewing the list of components in preparation for inspection;
automatically updating the database that at least one component in the list of components passed inspection by scanning the identifier on the at least one component;
receiving a ready-for-installation notice that the at least one component is ready for installation;
installing the at least one component into the aircraft,
automatically updating the database that at least one component in the list of components was installed by scanning the identifier on the at least one component;
receiving a ready-for-final-inspection notice that the installation is ready for a final inspection;
performing a final inspection; and
closing out the work order.

2. The method of claim 1, wherein the method further comprises the step of manually entering information into the database relating to the at least one component.

3. The method of claim 1, further including the step of manually searching for the at least one component in the database.

4. The method of claim 1, wherein the method further comprises the step of entering any added requirements relating to the at least one component after the final inspection is performed, prior to closing the work order.

5. The method of claim 1, wherein the information relating to the at least one component includes at least one of: a work order, an aircraft, a location, a part designation, an ATA code, an ATA chapter, an item number, a sticker, barcode reference, an image of the component, a discrepancy found during removal, a reason the component was removed, a person who removed the component, a time stamp associated with the removal, a type of inspection required for reinstallation, and an added requirements after installation is complete.

6. The method of claim 4 wherein the added requirement includes at least one of: an IE check, an OPS check, a leak check, a sealant requirement, and a paint requirement.

7. The method of claim 1, wherein the identifier is a scannable sticker.

8. The method of claim 7, wherein the scannable sticker comprises at least one of: a QR code, a barcode, a nearfield communication (NFC) chip, and a radio-frequency identification (RFID).

9. The method of claim 1, wherein the identifier is embossed onto the at least one component.

10. The method of claim 1, wherein the identifier is laser engraved into the at least one component.

11. The method of claim 1, wherein the identifier is etched into the at least one component.

12. The method of claim 1, wherein the identifier is painted onto the at least one component.
